(19) United States
(12) Patent Application Publication
(10) Pub. No.: US 2007/0131085 A1
(43) Pub. Date: Jun. 14, 2007

(54) Secure Guitar Strap

(76) Inventor: Marion G. Abbick, Junction City, KS (US)

Correspondence Address: MARTIN S. HIGH, P.O. BOX 217, STILLWATER, OK, 74076, US

(21) Appl. No.: 11/608,882

(22) Filed: Dec. 11, 2006

Related U.S. Application Data
(60) Provisional application No. 60/749,204, filed on Dec. 9, 2005.

(51) Int. Cl. G10G 5/00

(52) U.S. Cl. 84/327

(57) ABSTRACT

The instant invention is comprised of a leather strap and two pieces of cord formed in a loop. In the preferred embodiment of the invention, the loop is formed by sewing the two ends of a nylon cord together. The loop is then laced into the leather strap and the opposite end of the loop is used as a method of securing on to the guitar strap button. The opposite end of the loop is secured to the guitar strap button using a leather stop within which a stop hole is formed. The opposite end of the loop is threaded through the stop hole, the loop is placed over the guitar strap button, and the leather stop is tightened around the guitar strap button. Both ends of the guitar strap are secured to the guitar in the same manner to form a device to securely suspend a guitar.

### CROSS-REFERENCE TO RELATED APPLICATIONS

This application claims the benefit of U.S. Provisional Application No. 60/749,204, filed on Dec. 9, 2005. U.S. Provisional Patent Application No. 60/749,204 is incorporated by reference in its entirety for all purposes as if fully set forth herein.

### STATEMENT REGARDING FEDERALLY SPONSORED RESEARCH OR DEVELOPMENT

Not applicable.

### REFERENCE TO A “SEQUENCE LISTING,” A TABLE, OR A COMPUTER PROGRAM LISTING

Not applicable.

### BACKGROUND OF THE INVENTION

1. Field of Invention

The field of the instant invention pertains generally to devices for holding guitars around the neck of guitar players.

2. Description of Prior Art

The prior art in this area can be generally described as a leather or woven fabric strap that is connected directly to the guitar, or first connected to a cord or string which is then in turn connected to the guitar. The connection to the guitar is typically via the guitar strap buttons which are integrally affixed to the guitar at both the mid-section of the guitar and also the butt end of the guitar. In some cases, no guitar strap button is available at the mid-section of the guitar so a cord or string attached to the guitar strap is used to secure the guitar strap to the peg head of the guitar.

The prior art which uses only a strap teaches using button holes on both ends of the strap. The button holes are comprised of a slit formed in the strap and a circular or oval enlargement of the slit at one end of the slit. The strap is used by slipping the button hole over the button on the guitar. Since both ends of the strap form button holes, each end is affixed to any available buttons on the guitar at the mid-section and the butt end of the guitar.

The main drawback of the prior art using a strap with a slit on the end is that the slit commonly falls off or can be dislodged from the guitar when a force along the major axis of the guitar is applied to the strap causing the guitar to slip and fall. One purpose of the instant invention is to eliminate this problem of dislodging the guitar at the same time making the attachment of the strap convenient; therefore, a goal is to teach a secure method of attaching a guitar strap to the guitar.

### BRIEF SUMMARY OF THE INVENTION

The instant invention is comprised of a flexible strap, two pieces of cord formed in a loop, and two or more stops. One piece of cord formed in a loop is attached to the strap at each end of the strap. The strap is comprised of any thin, flat, flexible material with sufficient strength to at least support the weight of a guitar. In one preferred embodiment the strap is comprised of leather, and in another preferred embodiment the strap is comprised of woven material. The two pieces of cord are comprised of any thin flexible material with sufficient strength to at least support the weight of a guitar. The cord is comprised of material with a longitudinal length much greater than the diameter. A loop may be formed by joining the two ends of a cord. The two ends may be joined by sewing them together, knotting them together or by any other means that will result in a strong joint. The loop is then laced into the leather strap via a plurality of apertures formed in the leather strap. The opposite end of the loop is secured to a guitar strap button or to another portion of the guitar if a guitar button is not available. A stop is used as a means to secure the cord, with or without a knot, to the guitar button or the guitar. Within the center of the stop is formed a hole, the stop hole. The loop formed by the cord is threaded through the stop hole. The loop is then placed over the guitar strap button, and the stop is tightened around the guitar strap button.

The stop hole is formed such that when the loop is threaded through the stop hole and the stop tightened around the guitar strap button, the stop provides a sufficient friction fit as to prevent the stop from sliding easily on the loop thereby securing the guitar strap to the guitar strap button. The stop hole must be formed small enough to provide this friction fit, but sufficiently large enough for the user to thread the loop through the stop hole without special tools. In one preferred embodiment, the stop hole is formed to be large enough that a user can thread the loop into the stop hole using stiff thread or fishing line using a gloved hand. The stop hole is not necessarily round, but can be oblong in nature and is custom designed to suit the type of cord used to form the loop. In one preferred embodiment of the instant invention, the stop hole is an oblong slit, providing enough of a resistance fit to adequately secure the strap. In another embodiment of the invention the loop at the head end of the strap can be threaded underneath the strings above the nut at the head of the guitar and looped around the peg head and then be secured by passing the entire strap through the loop if the guitar is not equipped with a guitar strap button at the mid-section of the guitar.

There have thus been outlined, rather broadly, the more important features of the invention in order that the detailed description thereof that follows may be better understood, and in order that the present contribution to the art may be better appreciated. There are, of course, additional features of the invention that will be described hereinafter and which will form the subject matter of the claims appended hereto.

In this respect, before explaining at least one embodiment of the invention in detail, it is to be understood that the invention is not limited in this application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting. As such, those skilled in the art will appreciate that the conception, upon which this disclosure is based, may readily be utilized as a basis for the designing of other structures, methods and systems for carrying out the several purposes of the present invention. Additional benefits and advantages of the present invention will become apparent to those skilled in the art to which the present invention relates from the subsequent description of the preferred embodiment and the appended claims, taken in conjunction with the accompanying drawings. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application. The abstract is neither intended to define the invention of the application which is measured by the claims, nor is it intended to be limiting as to the scope of the invention in any way.

### BRIEF DESCRIPTION OF THE SEVERAL VIEWS OF THE DRAWING

FIG. 1 is a top view of an end of the secure guitar strap.

FIG. 2 is a view illustrating both ends of the secure guitar strap.

FIG. 3 is a view of the secure guitar strap showing a larks head knot used to secure a loop to a model guitar button (top) and illustrating an end of the secure guitar strap (bottom).

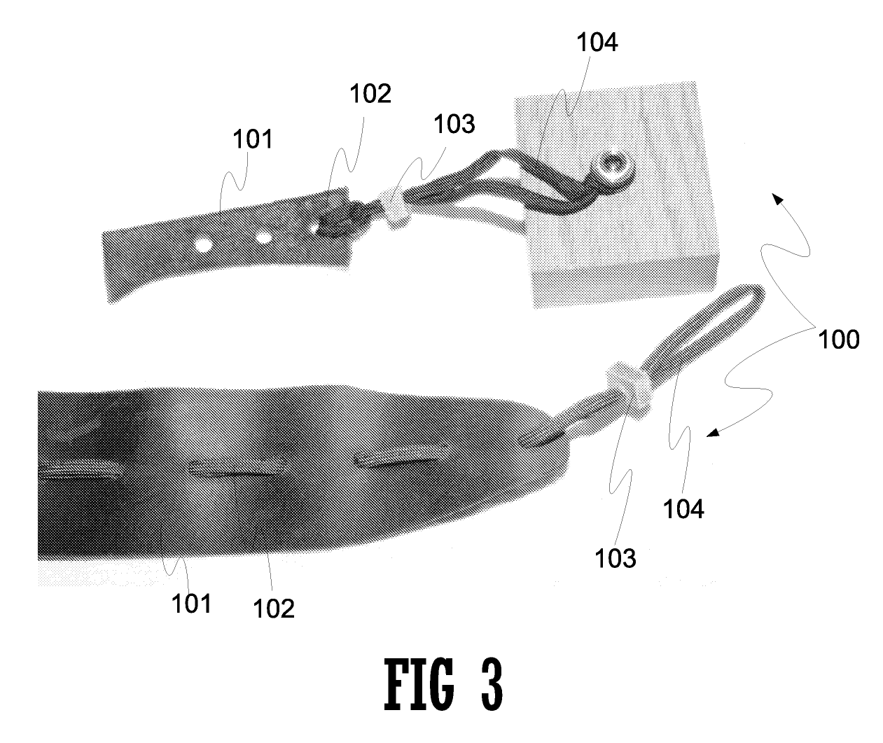

FIG. 4 is a view of the secure guitar strap showing how the loop is threaded through the holes formed by the strap.

FIG. 5 is a view illustrating a complete view of a preferred embodiment of the secure guitar strap.

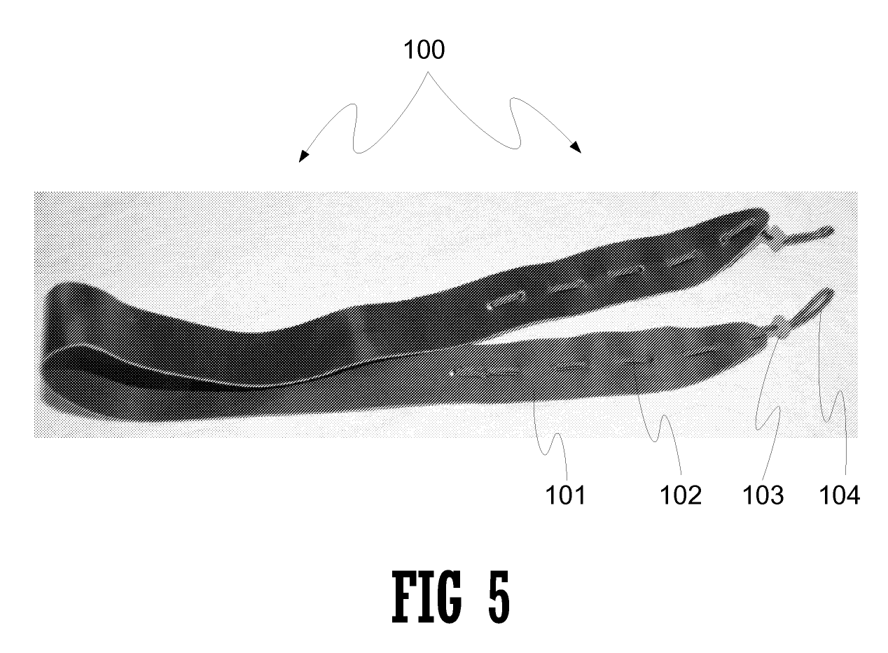

FIG. 6 is a view illustrating the secure guitar strap attached to a guitar button on a guitar with the stop pulled securely up to the guitar button.

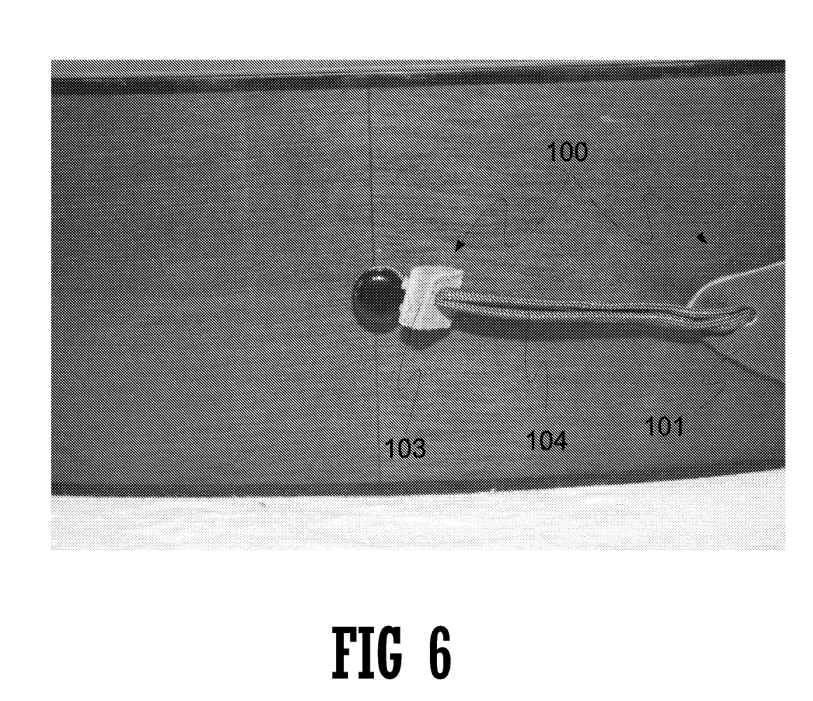

FIG. 7 is a view illustrating another preferred embodiment of the invention showing how the guitar may be secured by attaching a loop of the secure guitar strap to the head of the guitar.

### DETAILED DESCRIPTION OF THE INVENTION

The instant invention 100, the secure guitar strap, is comprised of a long, thin flexible strap 101, two pieces of cord each formed into a loop 104, and a plurality of stops 103. In one preferred embodiment of the invention, the flexible strap is comprised of leather or fabric. The two pieces of cord are each formed in a separate loop and are located on each end of the flexible strap. A loop is formed by joining the two ends of a cord. The two ends may be joined by sewing them together, knotting them together or by any other means that will result in a strong joint. The loop is then laced into the flexible strap 101. The opposite end of each loop is used as a method of securing the flexible strap 101 onto the guitar strap button located on the guitar. In one preferred embodiment of the invention, 550 parachute cord is used with just the outer sheath of the parachute cord; the inner threads of the parachute cord having been removed from the outer sheath. The term “550 parachute cord” is to be broadly construed as a high strength woven material commonly used in applications requiring high strength, but light weight cord.

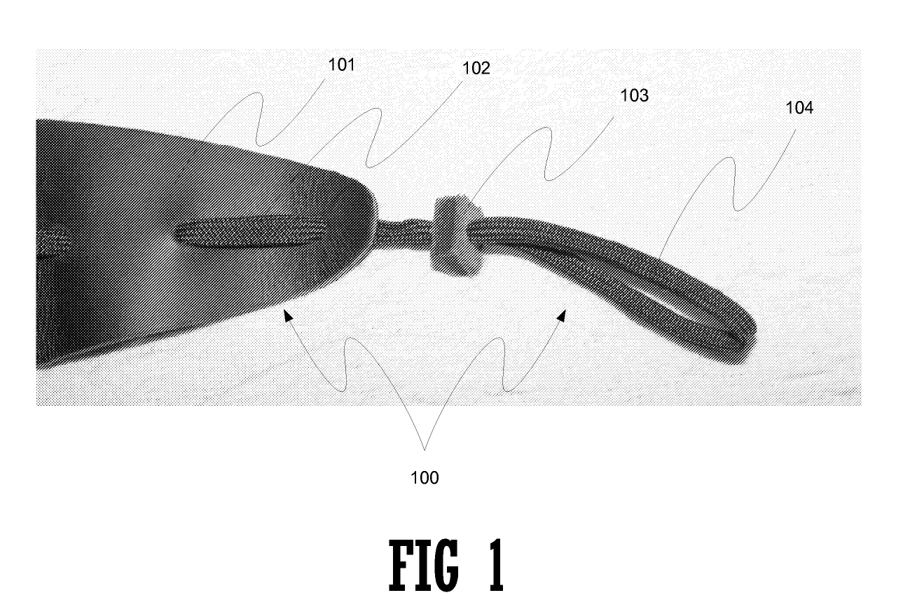

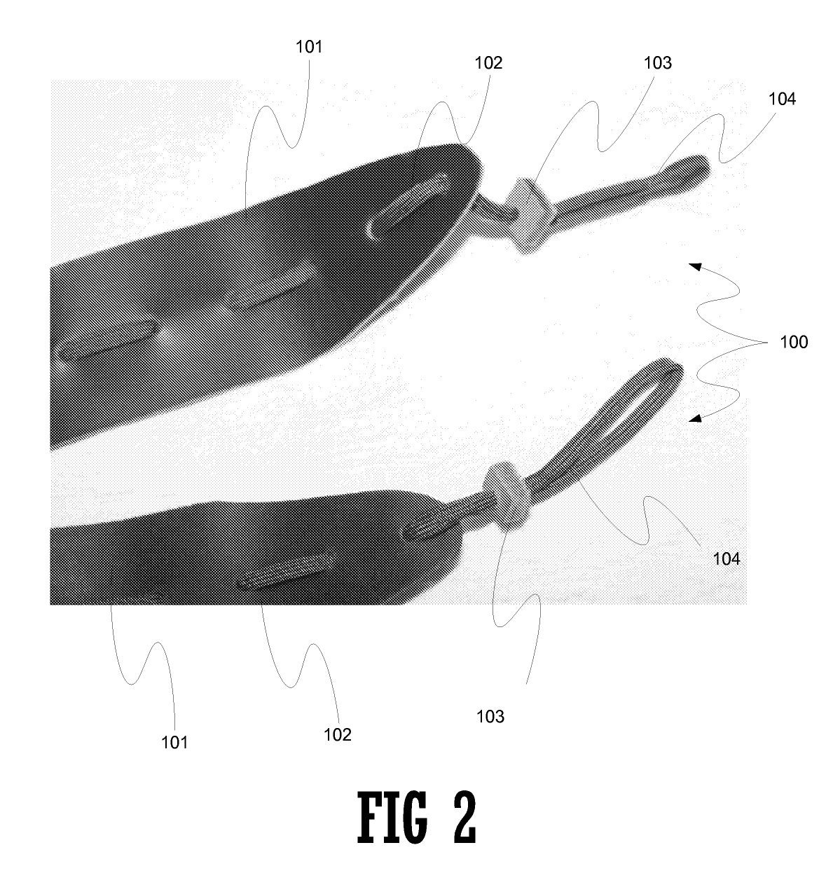

In one preferred embodiment of the instant invention, each loop is secured to a guitar strap button using a stop 103. The stop 103 is comprised of a small square, round or rectangular piece of a compliant material. In one preferred embodiment of the instant invention, the stop 103 is comprised of leather (as illustrated with a leather stop in FIG. 1). Two or more stops 103 are used in the instant invention 100. In most embodiments two stops are used, one stop 103 at both ends of the strap with each stop located on a loop 104 (illustrated in FIG. 2). A stop hole is formed by the stop in the center of the stop through which a loop passes. A loop is threaded through a stop hole, and the loop is placed over a guitar strap button, and the stop is tightened around the guitar strap button. In other words, to secure each loop on a guitar strap button on a guitar a loop is threaded through the hole formed in the stop and the loop secured around the guitar strap button by tightening the stop along the loop in the direction of the guitar strap button.

In another preferred embodiment of the instant invention the loop can be threaded over the guitar button and knotted onto the guitar button, for example using a larks head knot to secure the guitar strap to the button, and then the stop tightened over the guitar button.

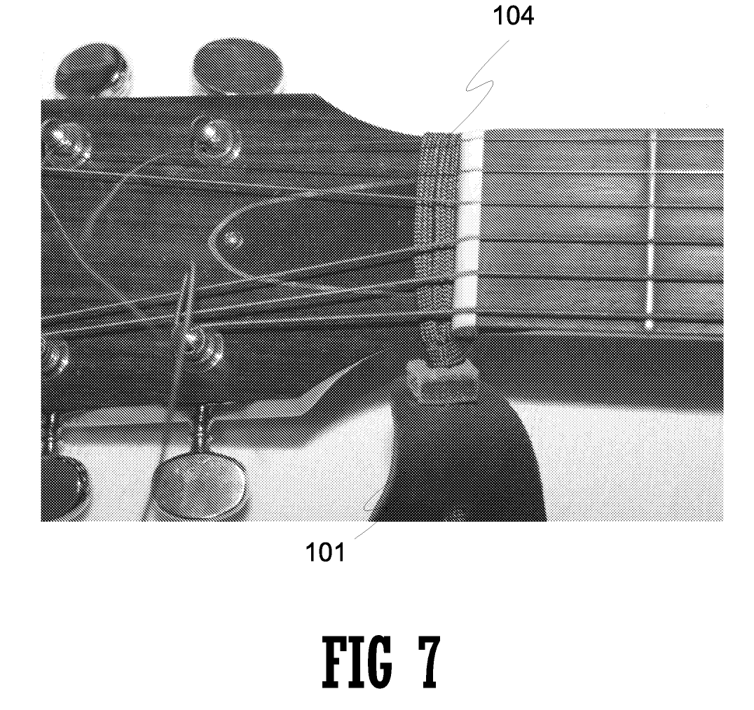

In another embodiment of the instant invention the loop 104 can be threaded underneath the strings above the nut at the head of the guitar and looped around the peg head and then be secured by passing the entire strap through the loop if the guitar is not equipped with a guitar strap button at the mid-section of the guitar. This preferred embodiment of the invention using the loop around the head end of the guitar is illustrated in FIG. 7.

In yet another embodiment of the instant invention the loop can be formed into a larks head knot and simply slipped over the guitar button without tightening the leather stop.

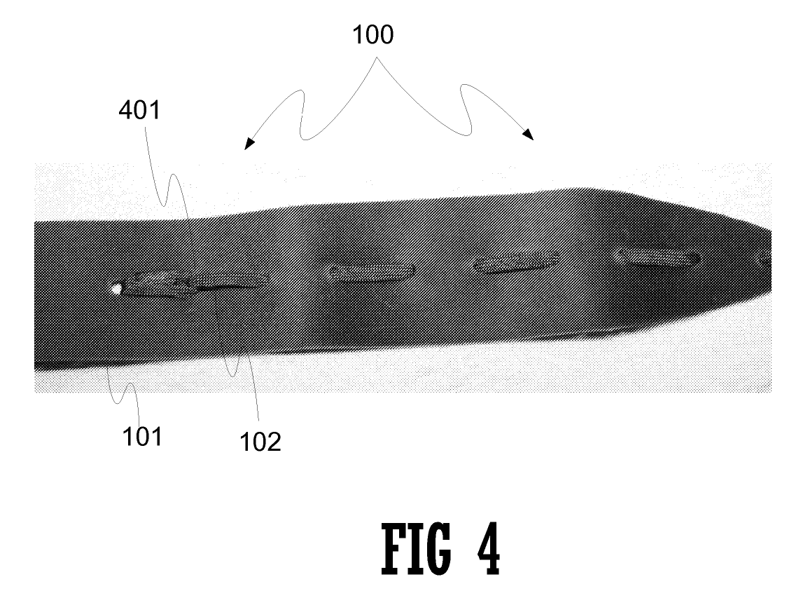

In the best mode of operation of the instant invention the loop is laced 102 through the strap. More specifically, one end of the loop is laced through the strap and the other end of the loop is used to secure the strap to the guitar button. The end of the loop that is laced through the strap is secured to the strap by looping the cord through itself 401 as is illustrated in FIG. 4. The end of the loop that is used to secure the strap to the guitar button is threaded through the stop hole. The instant invention then can be looped over the guitar button. The stop can then be slid down the end of the loop and tightened around the guitar button. The loop can be used to secure the strap to the guitar on the bottom guitar button as described in the other preferred embodiments above.

What is claimed is:

1. A guitar strap comprising
a flexible strap with two ends where the ends form a plurality of apertures,
where the flexible strap is manufactured from a flexible but strong material,
a loop of cord affixed to each end of the flexible strap threaded through the plurality of apertures,
and a plurality of stops.

2. The guitar strap as described in claim 1 wherein the flexible strap is a flexible leather strap or a flexible fabric strap.

3. The guitar strap as described in claim 1 wherein
the loops are each formed by joining the two ends of one cord by sewing the ends together, knotting them together or by any other means that will result in a strong joint.

4. The guitar strap as described in claim 3 wherein the loops are comprised of parachute cord.

5. The guitar strap as described in claim 1 wherein the plurality of stops is comprised of
two stops wherein the stops are used to secure each loop on a guitar strap button on a guitar by threading the loop through a hole formed in the stop and securing the loop around the guitar strap button by tightening the stop along the loop to the guitar strap button.

6. The guitar strap as described in claim 5 wherein the hole in the stop is formed of a size and shape such that a when the loop is threaded through the hole a resistance fit is formed so that when the stop is tightened the stop securely holds the guitar strap to the guitar strap button.

7. The guitar strap as described in claim 6 wherein the stops are a small square, round or rectangular compliant material.

8. The guitar strap as described in claim 7 wherein the compliant material is leather.

9. The guitar strap as described in claim 1 wherein the guitar strap is secured to the guitar by threading the loops over the guitar button and the loops knotted onto the guitar button.

10. The guitar strap as described in claim 1 wherein the guitar strap is secured to the guitar by threading a loop underneath the strings above the nut at the head of the guitar and looped around the peg head and then secured by passing the entire strap through the loop.
